(19) United States
(12) Patent Application Publication
(10) Pub. No.: US 2011/0022449 A1
(43) Pub. Date: Jan. 27, 2011

(54) Multimedia User Interfaces For Documents And Associated Digital Videos

(75) Inventor: Philip E. Bourne, Poway, CA (US)

Correspondence Address: FISH & RICHARDSON P.C. (SD), P.O. BOX 1022, MINNEAPOLIS, MN, 55440-1022, US

(73) Assignee: THE REGENTS OF THE UNIVERSITY OF CALIFORNIA, Oakland, CA (US)

(21) Appl. No.: 12/597,904

(22) PCT Filed: Apr. 28, 2008
(86) PCT No.: PCT/US08/61814

§ 371 Date: Oct. 4, 2010

Related U.S. Application Data
(60) Provisional application No. 60/914,715, filed on Apr. 27, 2007.

(51) Int. Cl. G06F 3/01; G06Q 30/00

(52) U.S. Cl. 705/14.4; 715/719

(57) ABSTRACT

Generating a multimedia user interface with synchronized digital video and document content can include receiving a document, receiving a digital video that corresponds to the document, generating a plurality of mappings, wherein each of the mappings maps a section of the document to a segment of the digital video, and generating a multimedia user interface responsive to the document, the digital video, and the plurality of mappings.

### CROSS-REFERENCE TO RELATED APPLICATIONS

This application claims priority to U.S. Provisional Application Ser. No. 60/914,715, titled “On-line Multimedia Systems for Providing Overview and Tutorial on a Written Text,” filed on Apr. 27, 2007, the disclosure of which is incorporated herein by reference in its entirety.

### FEDERALLY SPONSORED RESEARCH OR DEVELOPMENT

The U.S. Government may have certain rights in the invention described in this application pursuant to Grant Nos. 0544575 and 0732706 awarded by the National Science Foundation.

### BACKGROUND

This application relates to access to digital documents in a computer network.

Documents such as scientific articles, technical manuals, educational material convey information to a reader. Documents can be organized into multiple sections and can include figures and tables. Communication networks such as the Internet can enable access to such documents. Readers can use browsers or standalone software applications to view and download documents over the Internet.

### SUMMARY

This specification describes technologies that, among other things, provide a multimedia user interface that can effectively communicate a document's content.

A method for generating a multimedia user interface for reviewing a scientific article by associating digital video content to the scientific article can include operating a network server to receive a scientific article, operating a network server to receive a digital video whose contents describe at least a portion of the scientific article, and generating a multimedia user interface responsive to the scientific article and the digital video. Other implementations can include corresponding systems, apparatus, and computer program products.

These, and other aspects, can include one or more of the following features. The generated multimedia user interface can include a link to the digital video. Generating the multimedia user interface can include generating code to display at least a portion of the scientific article and the link. The features can include generating mappings between the scientific article and the digital video, wherein each mapping identifies a section of the scientific article to a corresponding portion of the digital video, generating links that correspond to the mappings, and augmenting the multimedia user interface with at least a portion of the links. The links can allow a user to view different portions of the digital video respective to ones link. The links can allow a user to view different sections of the document respective to ones link. The generated multimedia user interface can include a link to the scientific article. Generating the multimedia user interface can include generating code to view the digital video. The features can include providing a user interface to rank the scientific article and receiving ranking information through the user interface. The features can also include augmenting the multimedia user interface with one or more advertisements.

A method for generating a multimedia user interface on a network server with synchronized digital video and document content can include receiving a document, receiving a digital video that corresponds to the document, generating a plurality of mappings, wherein each of the mappings maps a section of the document to a segment of the digital video, and generating a multimedia user interface responsive to the document, the digital video, and the plurality of mappings. Other implementations can include corresponding systems, apparatus, and computer program products.

These, and other aspects, can include one or more of the following features. Each mapping can include a time offset relative to the digital video, a time range that begins at the time offset, and a section identifier that identifies a section of the document. Generating the multimedia user interface can include generating code for displaying the digital video, code for displaying at least a portion of the document, and code for synchronizing a display of at least a portion of the document with a display of the digital video by using the plurality of mappings. Generating the multimedia user interface can include creating links that correspond to one or more of the mappings. The document can include text and one or more figures.

A method for displaying a multimedia user interface can include accessing a document, a digital video that corresponds to the document, and a plurality of mappings that are stored collectively between one or more storage mediums, wherein each of the mappings maps a section of the document to a segment of the digital video; displaying a multimedia user interface responsive to the document, digital video, and the plurality of mappings; playing the digital video; identifying a corresponding section of the document that corresponds to a currently displayed portion of the digital video; and displaying the corresponding section of the document in the multimedia user interface. Other implementations can include corresponding systems, apparatus, and computer program products.

These, and other aspects, can include one or more of the following features. The features can include displaying the mappings as links in the multimedia user interface; receiving a selection of a link via the multimedia user interface; and starting the playing of the digital video with respect to a mapping identified by the received selection. The document can include text and one or more figures. The features can also include displaying one or more advertisements in the multimedia user interface.

A system for generating a multimedia user interface for reviewing a scientific article by associating digital video content to the scientific article, can include a communication network to provide connectivity to multiple computers; and a first computer connected to the communication network, wherein the first computer performs operations that can include receiving a scientific article from the communication network; receiving a digital video whose contents describe at least a portion of the scientific article from the communication network; and generating a multimedia user interface responsive to the scientific article and the digital video.

This, and other aspects, can include one or more of the following features. The generated multimedia user interface can include a link to the digital video. Generating the multimedia user interface can include generating code to display at least a portion of the scientific article and the link. The operations can include generating mappings between the scientific article and the digital video, wherein each mapping identifies a section of the scientific article to a corresponding portion of the digital video, generating links that correspond to the mappings, and augmenting the multimedia user interface with at least a portion of the links. The links can allow a user to view different portions of the digital video respective to ones link. The links can allow a user to view different sections of the document respective to ones link. The generated multimedia user interface can include a link to the scientific article. Generating the multimedia user interface can include generating code to view the digital video. The operations can include providing a user interface to rank the scientific article and receiving ranking information through the user interface. The operations can also include augmenting the multimedia user interface with one or more advertisements.

A system for generating a multimedia user interface with synchronized digital video and document content can include a communication network to provide connectivity to multiple computers; and a first computer connected to the communication network, wherein the first computer performs operations that can include receiving a document from the communication network; receiving a digital video that corresponds to the document from the communication network; generating a plurality of mappings, wherein each of the mappings maps a section of the document to a segment of the digital video; and generating a multimedia user interface responsive to the document, the digital video, and the plurality of mappings.

This, and other aspects, can include one or more of the following features. Each mapping can include a time offset relative to the digital video, a time range that begins at the time offset, and a section identifier that identifies a section of the document. Generating the multimedia user interface can include generating code for displaying the digital video, code for displaying at least a portion of the document, and code for synchronizing a display of at least a portion of the document with a display of the digital video by using the plurality of mappings. Generating the multimedia user interface can include creating links that correspond to one or more of the mappings. The document can include text and one or more figures.

A system for displaying a multimedia user interface can include a communication network to provide connectivity to multiple computers; a first computer connect to the communication network; and a second computer connected to the communication network. The second computer can perform operations that include accessing a document, a digital video that corresponds to the document, and a plurality of mappings stored in the communication network, wherein each of the mappings maps a section of the document to a segment of the digital video; displaying a multimedia user interface responsive to the document, digital video, and the plurality of mappings to the first computer; playing the digital video to the first computer; identifying a corresponding section of the document that corresponds to a currently displayed portion of the digital video; and displaying the corresponding section of the document in the multimedia user interface to the first computer.

This, and other aspects, can include one or more of the following features. The operations can also include displaying the mappings as links in the multimedia user interface; receiving a selection of a link via the multimedia user interface; and starting the playing of the digital video with respect to a mapping identified by the received selection. The document can include text and one or more figures. The operations can also include displaying one or more advertisements in the multimedia user interface.

A computer program product, tangibly embodied on a computer-readable medium, the computer program product comprising instructions to enable a data processing apparatus to perform operations that can include operating a network server to receive a scientific article, operating a network server to receive a digital video whose contents describe at least a portion of the scientific article, and generating a multimedia user interface responsive to the scientific article and the digital video.

This, and other aspects, can include one or more of the following features. The generated multimedia user interface can include a link to the digital video. Generating the multimedia user interface can include generating code to display at least a portion of the scientific article and the link. The features can include generating mappings between the scientific article and the digital video, wherein each mapping identifies a section of the scientific article to a corresponding portion of the digital video, generating links that correspond to the mappings, and augmenting the multimedia user interface with at least a portion of the links. The links can allow a user to view different portions of the digital video respective to ones link. The links can allow a user to view different sections of the document respective to ones link. The generated multimedia user interface can include a link to the scientific article. Generating the multimedia user interface can include generating code to view the digital video. The features can include providing a user interface to rank the scientific article and receiving ranking information through the user interface. The features can also include augmenting the multimedia user interface with one or more advertisements.

A computer program product, tangibly embodied on a computer-readable medium, the computer program product comprising instructions to enable a data processing apparatus to perform operations that can include receiving a document, receiving a digital video that corresponds to the document, generating a plurality of mappings, wherein each of the mappings maps a section of the document to a segment of the digital video, and generating a multimedia user interface responsive to the document, the digital video, and the plurality of mappings.

This, and other aspects, can include one or more of the following features. Each mapping can include a time offset relative to the digital video, a time range that begins at the time offset, and a section identifier that identifies a section of the document. Generating the multimedia user interface can include generating code for displaying the digital video, code for displaying at least a portion of the document, and code for synchronizing a display of at least a portion of the document with a display of the digital video by using the plurality of mappings. Generating the multimedia user interface can include creating links that correspond to one or more of the mappings. The document can include text and one or more figures.

A computer program product, tangibly embodied on a computer-readable medium, the computer program product comprising instructions to enable a data processing apparatus to perform operations that can include accessing a document, a digital video that corresponds to the document, and a plurality of mappings that are stored collectively between one or more storage mediums, wherein each of the mappings maps a section of the document to a segment of the digital video; displaying a multimedia user interface responsive to the document, digital video, and the plurality of mappings; playing the digital video; identifying a corresponding section of the document that corresponds to a currently displayed portion of the digital video; and displaying the corresponding section of the document in the multimedia user interface.

This, and other aspects, can include one or more of the following features. The features can include displaying the mappings as links in the multimedia user interface; receiving a selection of a link via the multimedia user interface; and starting the playing of the digital video with respect to a mapping identified by the received selection. The document can include text and one or more figures. The features can also include displaying one or more advertisements in the multimedia user interface.

Particular implementations of the subject matter described in this specification can be implemented to realize one or more of the following potential advantages. The presentation of a digital video can readily explain sections of a document or give general highlights of the document. Generating one or more mappings between a digital video and a corresponding document can allow a user to view portions of the document as they are being discussed in the digital video. Further, the mappings can allow a user to jump to a section within the document and/or digital video.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows an example of a multimedia user interface.

FIG. 2 shows another example of a multimedia user interface.

FIGS. 3A,B,C show different examples of multimedia user interfaces with different link placements.

FIG. 4 shows an example of a generating a multimedia user interface.

FIG. 5 shows an example of mapping digital video content to document content.

FIG. 6 shows an example of displaying a multimedia user interface.

FIG. 7 shows an example of an architecture of a content provider site.

FIG. 8 shows an example of an architecture for an upload process.

FIG. 9 shows an example of a communication network connected with computing devices.

Like reference symbols in the various drawings indicate like elements.

### DETAILED DESCRIPTION

Documents can convey a lot of information. Readers of an information dense document can benefit from watching a digital video that describes the contents of the document. The digital video can include audio and visual media content. A digital video can capture an author giving an overview of his document and/or describing one or more figures included in the document. A multimedia approach can be effective in presenting information contained in a document. The multimedia approach can include displaying text, digital video, audio, hyperlinks, links, and combinations thereof. Hyperlinks and links can direct a user to different portions of the document, digital video, or other related content. Different multimedia modes can be used at different time. The multimedia approach can also include synchronizing the digital video with content of the document.

In a document such as a scientific article, written paper or text, readers of such a document can readily understand the concepts contained in the document by viewing a digital video presentation that includes a brief motivation for the research, the key findings, the unique features of the methodology, and a discussion of the implications of the findings found in the document. Typically, the digital video can last for 10 minutes. However, the digital video can be shorter or longer. Additional digital video content can include visual simulations, visual tours of intricate experiments, and educational lectures. Digital video content can also include lectures, tutorials, demonstrations, and panel discussions. A pubcast refers to the association of an article to a digital video describing the article.

Other documents can include physician briefs, how-to manuals, poster presentations, and educational material. For example, a how-to manual that describes how to assemble a computer can be made into a digital video. The digital video can include multiple sections. Each section can explain a different step in the computer's assembly. The digital video can be synchronized with the manual. When playing back the digital video, the corresponding section of the manual can be displayed to the user. The corresponding section can include diagrams that further aid a user in understanding how to assemble the computer. If a user needs help in a specified section, the user can jump to the specified section of the manual through a user interface and access the corresponding section of the digital video.

A collection of digital video presentations can form the foundation for establishing a virtual community who can rate and discuss the work in conjunction with the corresponding written papers. The integrity and scientific merit of the collection and the subsequent discussion can be monitored by the community. Community peer review can lead to high quality entries in the collection. Further, a ranking system can be incorporated with the collection to provide ranking information for digital videos within the collection and their associated articles.

An electronic dialog can be provided so that users within the virtual community can comment on the digital videos and associated articles. The electronic dialog can be used for questions and answers and for making general comments. The comments can be made publicly, restricted to the authors of the document, or restricted to the user for his own future reference. The author can respond to the questions and comments through the dialog. Additionally, other members of the virtual community can respond. Through the electronic dialog, the material presented in the paper and discussed in the digital video can be scientifically enriched by audience/user participation.

The scientific article or paper can be published in an open access repository such as those found in the Public Library of Science (PLoS) or PubMed as operated under the National Institutes for Health (NIH). When a paper is published, the author(s) of the paper can be given the opportunity to upload a digital video presentation of the paper. This opportunity can be in the form of an e-mail asking them to submit a digital video or can be an additional step of the submission process. Thus, the digital video can be submitted with the paper or submitted after the paper has been submitted. Further, the submission of the digital video can be used in the paper's acceptance process.

When one of the authors of a submitted paper agrees to provide video content, each author of the paper can be sent an e-mail directing the author to a web site where the author will be asked to accept the conditions imposed by the service hosting the video content. The conditions can include that submitted digital video is an accurate and true depiction of the corresponding published paper and to license the video content under specified terms and conditions. For example, the license can be a creative commons license as drafted by Creative Commons of San Francisco, Calif. (www.creativecommons.org).

Uploaded digital video content can be reviewed by an external reviewer. Users viewing the content can also make comments. These reviews and comments can be used to accept the paper and move the content to a production site for all to see. Also, an authentication process can be employed to control who uploads content. When an author agrees to upload a digital video, he can be sent a Uniform Resource Locator (URL) via e-mail using the author's e-mail address given in the corresponding article. The video can then be placed in a holding area whereupon all authors can be sent a URL to go to a location where the submitted contents can be reviewed. Once all authors have accepted the content, the content can be automatically released to the production site.

Digital videos can be modified for legal and monetary concerns. For example, a legal disclaimer can be added to the beginning of a digital video. A legal disclaimer can include a statement that the hosting service does not take responsibility for the accuracy or validity of the content presented in the digital video and a statement regarding the association between the digital video and associated document. In some implementations, ads for products, services, or recognition of sponsorship can be added to a digital video.

The open access repositories can be augmented to provide access to author information and links between video presentations and paper abstracts. Alternatively, a different site on the Internet can host one or more collections of digital video. The site can also provide content found in the digital video's corresponding abstract and/or document. In some implementations, the site can provide links to the full article. For example, each entry in the collection can link to the full text of the respective PLoS article. The articles that have digital videos can link to their respective entries in the collection.

Video and other multimedia presentations of a written text can be stored on one or more computer servers. An on-line system, such as a content provider site hosted by a network server, can be provided to allow users to access the on-line multimedia presentations on the written texts. An abstract or the full text of a scientific paper, for example, can be provided on-line and the on-line system can be used to link digital video and other multimedia presentations specifically prepared for the scientific paper to the abstract or the full text of the scientific paper. An user interface can be provided for a user to browse available papers and texts and to select the corresponding video and multimedia presentations for a selected paper or text. The video and multimedia presentations for the paper can be an intermediate description of the subject matter of the paper and can provide information on the subject matter between the abstract and the full paper and can include additional information that is associated with the paper.

The content of the collection including the corresponding written papers can be searched to identify papers and digital video of interest to a user. Figures including images can be tagged with information to aid in search. Users can browse or search the collection based on metadata that can include authors, journal title, and field of science.

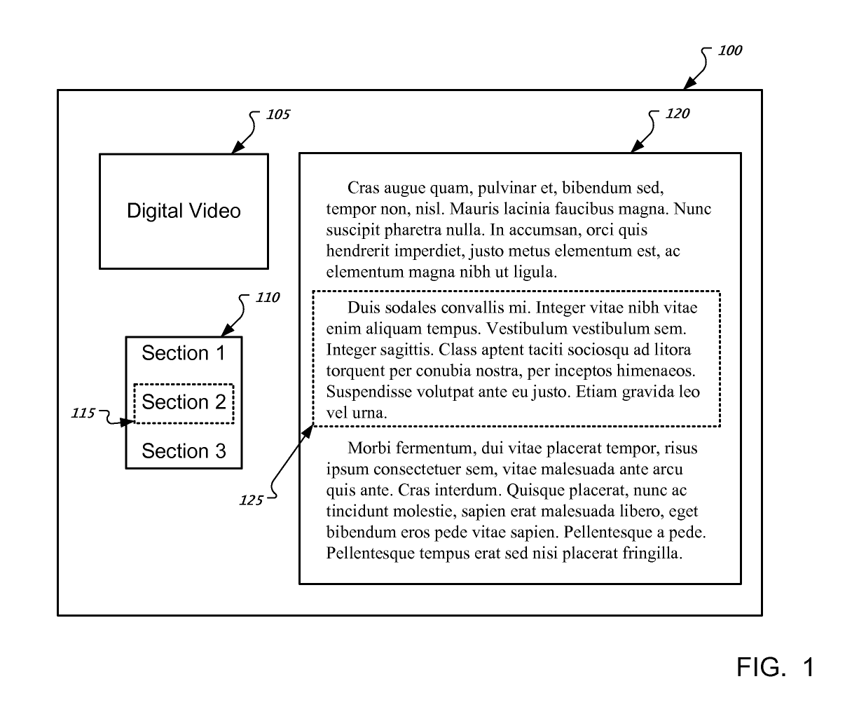

FIG. 1 shows an example of a multimedia user interface. A browser window or a standalone application can display a multimedia user interface. A multimedia user interface 100 can include multiple display regions for presenting data to a user or receive data or selection choices from a user. Further, the multimedia user interface can display digital video, a document that corresponds to the digital video, one or more portions of the document including text and or images, or any combination thereof. The multimedia user interface 100 can include a region 105 for playing a digital video, a document region 120 for displaying a document, or portions thereof, that corresponds to the presently displayed section of digital video in region 105. The document region can display a default section of the document when the digital video has not yet started to play. The default section can be the beginning of the document or an abstract associated with the document.

In some implementations, the interface 100 can include a table of contents (TOC) region 110. The TOC region 110 can display section headings that correspond to section headings of the document. A user can select a section such as selection 115 that selects “Section 2” through the TOC region 110. For example, the user can make the selection by clicking on a section heading within TOC region 110. Section headings can include definite sections as defined by an author of the document, the first few words of a paragraph, or figure or table references. If a user makes a selection such as selection 115, the corresponding portion 125 of the document can be displayed in document region 120. The corresponding portion 125 can be highlighted, circled, or boxed. Accordingly, the digital video shown in region 105 can be positioned or repositioned to correspond to the corresponding portion 125 of the document. As the digital video advances to describing the next section of the document, the document region 120 can also be advanced to the next section of the document. A user can select the beginning of the document/digital video to start or can start at a user selected portion of the document/digital video. The user can also advance or rewind the video through a media control command such as rewind or fast forward and the document region 120 can display an appropriate section of the document.

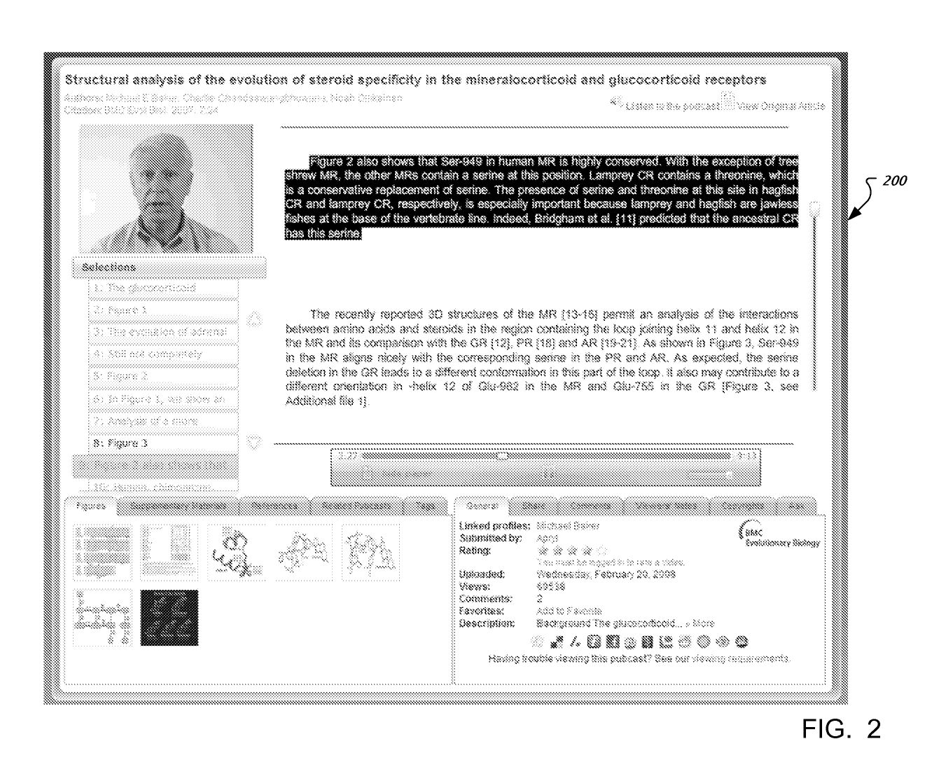

FIG. 2 shows another example of a multimedia user interface. The multimedia user interface 200 can include a region that displays a digital video, a TOC, and a portion of a document that corresponds to the current playback of the digital video. The corresponding portion of the document in this example is shown as highlighted text. The interface can include status information on the playback of the digital video such as a position within the playback and play/stop/pause controls. Additional features can include a rating mechanism, a comment section, and links to related documents and presentations. Documents can include figures. These figures can appear in a separate TOC region and can be used to navigate and control the playback of the digital video.

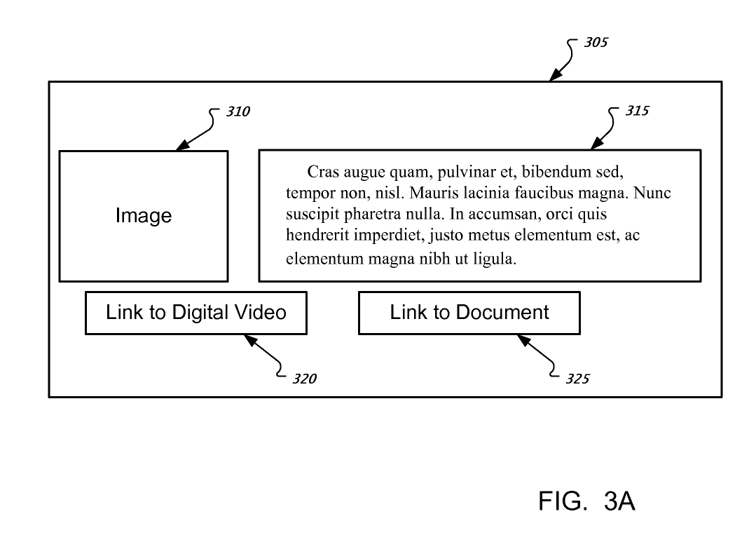

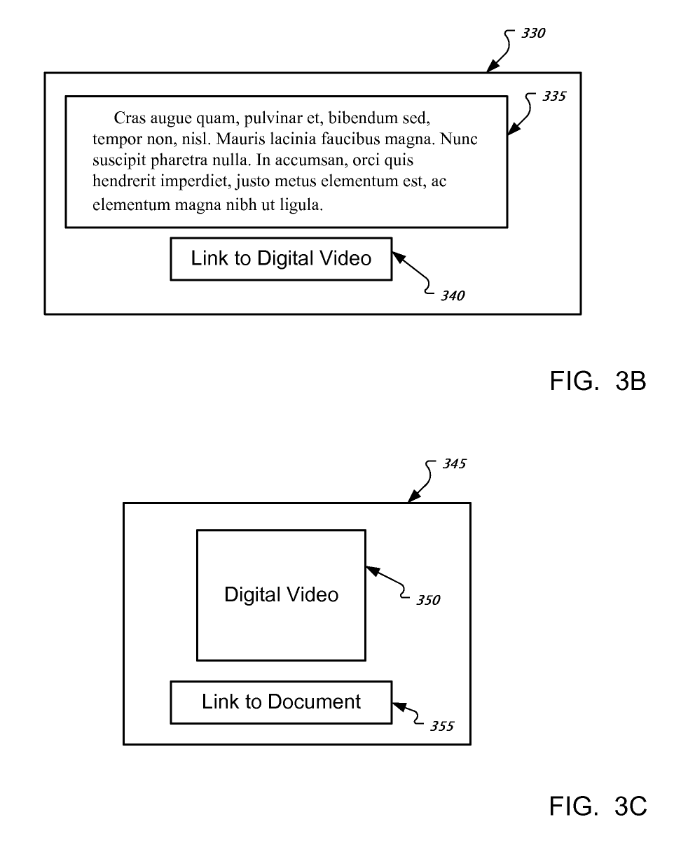

FIG. 3A shows another example of a multimedia user interface 305 with an associated digital video and document. The user interface 305 in this example can include a still image 310 of the digital video and a presentation region 315. Presentation region 315 can display an abstract associated with the document or a portion of the document. In some implementations, presentation region 315 can include figures associated with the document. The user interface 305 can include a link 320 to the digital video and a link 325 to the document.

FIG. 3B shows another example of a multimedia user interface 330 with an associated digital video and document. The user interface 330 in this example can include a presentation region 335 and a link 340 to the digital video. The presentation region 335 can display the entire document, a portion of the document, or an abstract associated with the document.

FIG. 3C shows another example of a multimedia user interface 345 with an associated digital video and document. The user interface 345 in this example can include a region 350 to display a digital video and a link 355 to the document associated with the digital video. In some implementations, the link 355 can take a user to a portion of a document that corresponds with the currently displayed section of the digital video playback. The user interface 345 can include multiple links implementations. In implementations with multiple links, a table of contents style arrangement can be used to manage the display of links.

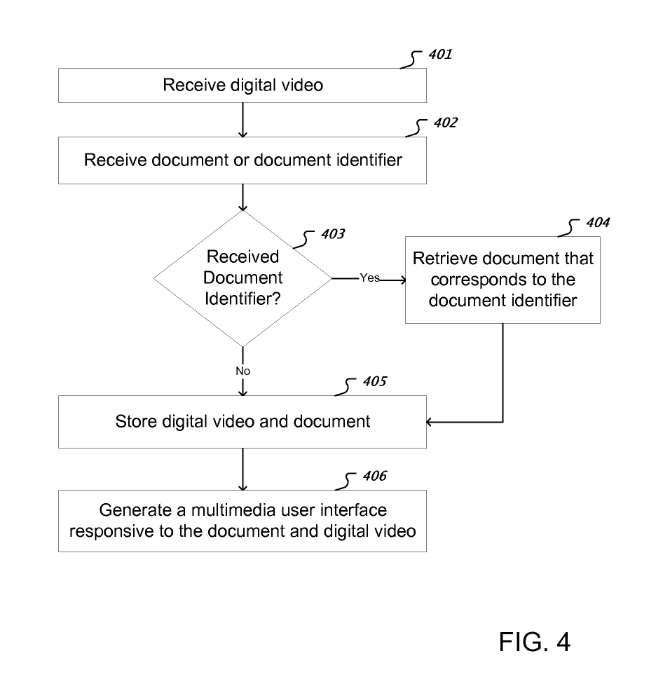

FIG. 4 shows an example of a generating a multimedia user interface. A content provider can receive 401 a digital video and can receive 402 a document or document identifier that corresponds to the document associated with the digital video. If a document identifier was received 403, then the document that corresponds to the document identifier can be retrieved 404. The digital video and document can be stored 405 on a computer storage medium. For example, one or more databases can be used to store the digital video and document on the computer storage medium. In some implementations, the document identifier or a link to the document can be stored in lieu of the document in order to save storage space. The content provider can generate 406 a multimedia user interface responsive to the document and digital video. One or more multimedia user interfaces can be generated and can take on the form of interfaces such as interfaces 100, 200, 305, 330, and 345. The generation process can include generating HTML and XML code, Adobe® Flash® content, and other web-based authoring code. The generated code and/or content can be stored on the same computer storage medium as the digital video and document or on a different medium.

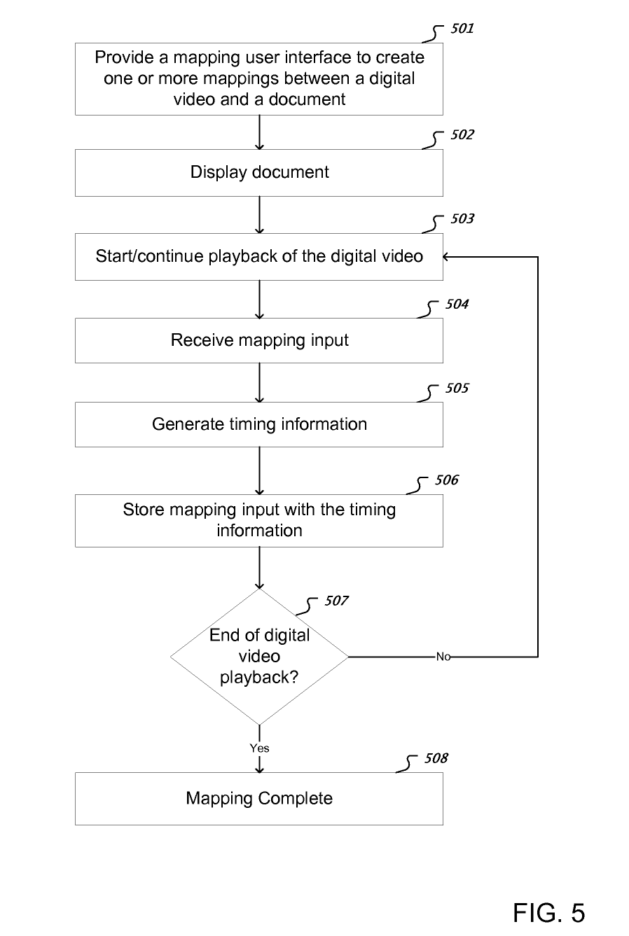

FIG. 5 shows an example of mapping digital video content to document content. The generation 406 of a multimedia user interface can include the generation of mappings. The content provider can provide 501 a mapping user interface to create one or more mappings between a digital video and an associated document. The document can be displayed 502 in the mapping user interface. Playback of the digital video can start 503 after the document is displayed. The interface can receive 504 mapping input. In some implementations, a mapping input can be generated by selecting a section or a figure of a document during playback of digital video. The selection can be effected by clicking on or by dragging and dropping the section of figure into a selection region of the interface. The selection region can be the region displaying the digital video or a separate region. In some implementations, an index denoting the figure or an index denoting the beginning and ending of a passage can be used as a document section identifier for the mapping input.

Timing information can be generated 505 by determining a time offset relative to the beginning of the video. in some implementations, the time offset can be determined by noting when the user made the section for the mapping input. The user interface can give a user the option of changing the time offset and for inputting a time range. The default time range can be the time elapsed in the video playback until the next mapping input is created. During playback of the finished product, the time offset can control when the specified section of the document will appear during playback of the video and the time range can control the duration of the appearance. The mapping input with the timing information including the time offset, time range, and section or figure index into the document can be stored 506 in a mapping file associated with the digital video and document. In some implementations, XML can be used to format the mapping file. If playback of digital video has ended 507, then mapping is complete 508 and the final mapping file can be saved to disk. Otherwise playback can continue 503.

The mappings can be used to generate links. These links can augment the multimedia user interface by appearing as entries in a table of contents, hyperlinks within the document, or other links within the interface. These links can direct a user to a respective portion of the document, a respective portion of the digital video, or a combination thereof.

Two different mappings can refer to two different sections of the document. Each of these two mappings can refer to different portions of the digital video.

Code for web browser or a standalone application can be generated for displaying the digital video and a section of the document. Code can also be generated for synchronizing the display of the digital video and the section of the document using the mapping information. Further, code can be generated to display mappings as links within a multimedia user interface.

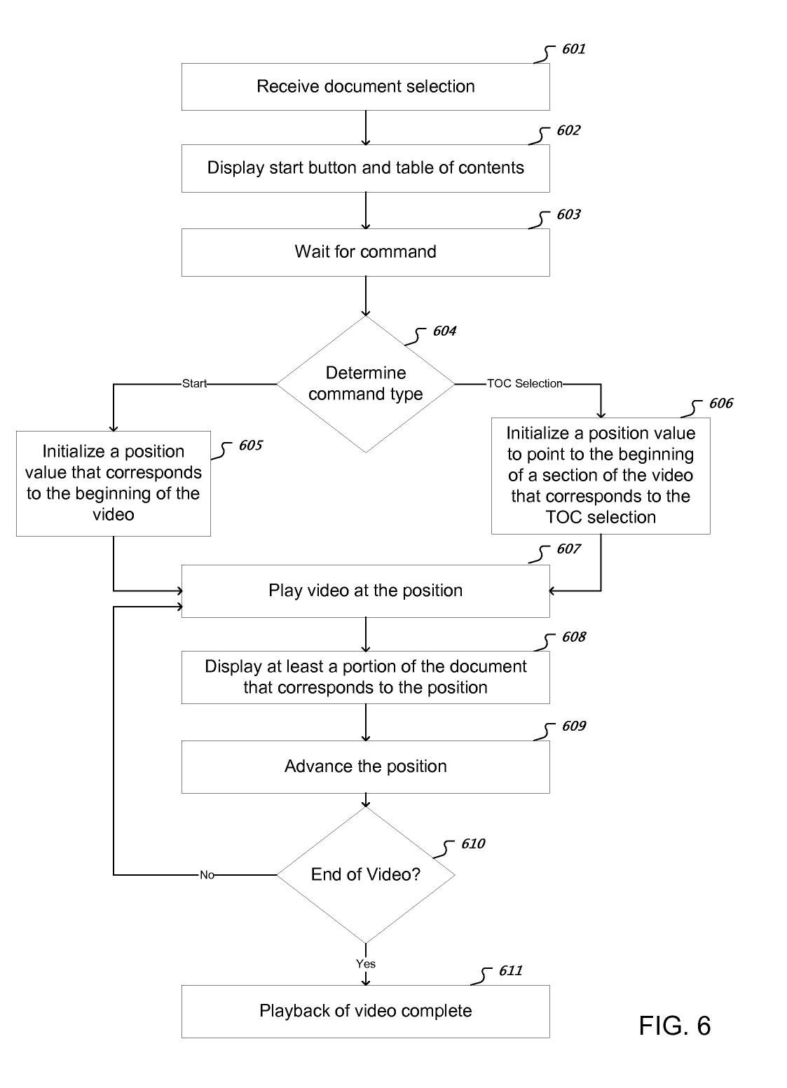

FIG. 6 shows an example of displaying a multimedia user interface. The content provider can display a collection of documents and digital videos in a web browser window. A user can browse or search the collection to find a document or digital video. Alternatively, a user can click on a link or enter in a document identifier to access the respective document and digital video. The content provider can receive 601 the document selection and can display 602 a multimedia user interface including a start button for the digital video and table of contents associated with the document and the digital video. The user interface can wait 603 for a command. The command type can be determined 604. For start commands, a position value that corresponds to the beginning of the video can be initialized 605. For TOC selection commands, a position value can be initialized 606 to point to the beginning of a section of the video that corresponds to the TOC selection. The position value can be a time index into the video. The multimedia user interface can start playing video 607 at the position. The digital video can be downloaded to the user's computer or can be streamed to the user. The interface can display 608 at least a portion of the document that corresponds to the position. The mapping file generated by the process shown in FIG. 5 can be used to synchronize the display of the document with the playback of the video. While the video is playing, the position can be advanced 609. If playback has not reached the end of the video 610, the playback can continue 607. Otherwise, playback of the video is complete 611.

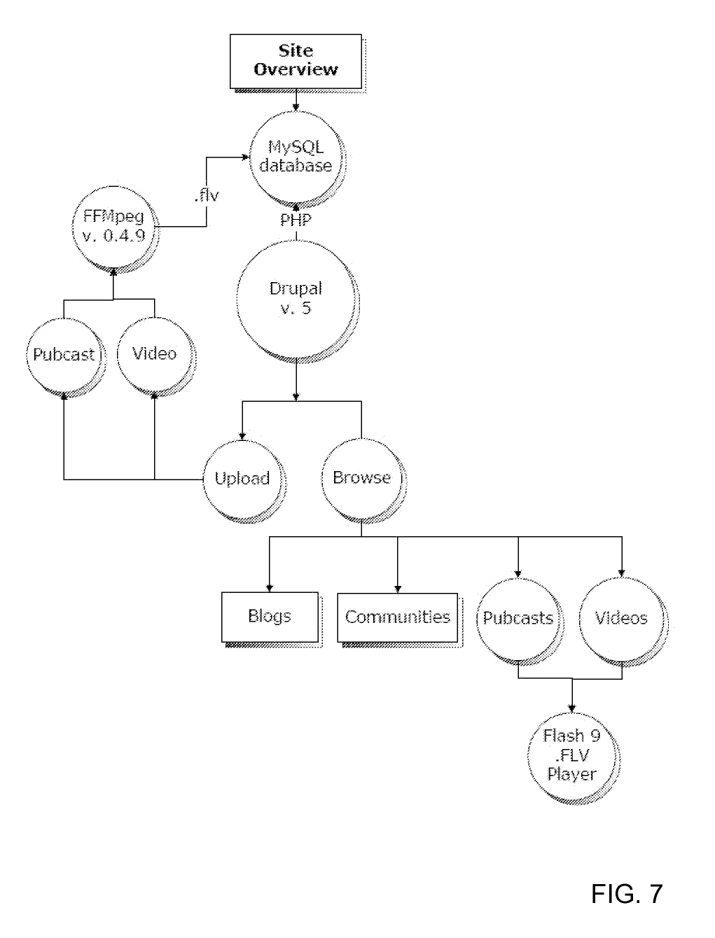

FIG. 7 shows an example of an architecture of a content provider site which includes an upload process and a browsing process. A content provider site, such as SciVee.tv, can be hosted on a network server such as a Linux based server which runs Apache, PHP, and MySQL. The Drupal content management system can be used to generate the site. The functionality of the content management system can be extended with modules created in PHP which can enable a process of uploading videos and publications to create a pubcast.

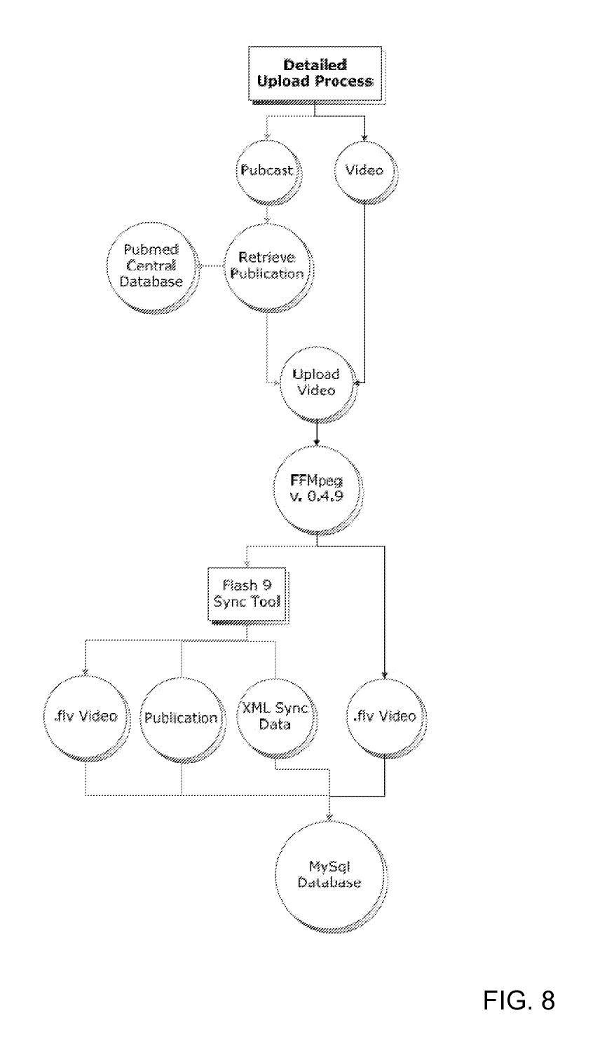

FIG. 8 shows an example of an architecture for an upload process. When a user visits an upload page of the content provider site, the user can enter the Pubmed ID or Digital Object Identifier of a scientific publication/article to proceed. Once entered, a module requests the publication from the publication database such as the Pubmed Central database, and once retrieved, stores the publication and associated files into a database such as MySQL. The user then uploads a digital video related to the scientific publication. The digital video can be stored in the database. Once the digital video has finished uploading, the server converts the digital video into the flash video format, .flv, using a conversion tool such as FFMPEG. When the conversion is complete, the user can be directed to a synchronization tool, that can be Adobe® Flash® based, which retrieves the user's publication, digital video, and related images. The synchronization tool can provide a mapping user interface in which a user can add additional content by mappings different areas of the digital video to the document. These mappings are then saved into an XML file. Once published, the pubcast is made accessible to all visitors and searchable through the Drupal search engine.

When a user visits the content provider site, the front end experience can be generated by Drupal, which calls the appropriate PHP modules for retrieving database information for browsing videos, communities, user profiles, and all other content on the site and displaying it through Drupal generated web templates. A custom Adobe® Flash® based player can access the XML file that includes the mapping information to recreate the presentation in a multimedia user interface.

A system for providing content can include at least one computer server connected to a communication network, such as the Internet, and configured to store multimedia files that respectively correspond to articles. Each multimedia file can include a video presentation of the subject matter of a respective article. The system can also include a presentation engine to provide a user interface which enables a user to search and view a list of articles for which multimedia files are available on the computer server and to select a multimedia file for viewing. In some implementations, the system can include a mechanism to link an on-line database of published articles to the presentation engine to allow a user to view information of an article stored in the on-line database, wherein a corresponding multimedia file for the article is stored on the computer server for retrieval.

Presenting multimedia information can include presenting an electronic version of an article, presenting an digital video, such as an electronic video abstract of said article, providing links within the article to appropriate time-stamps of the electronic video which allows a reader of the article to start the digital video at that time-stamp, and providing links within the digital video to appropriate sections of the article. Presenting the electronic version of the article can include presenting an abstract of the article, one or more sections of the article, or the full text of the article.

In some implementations, presenting multimedia information can include acts of electronic commerce. These acts can include presenting advertising appropriate to the content of both the video, the article, and the specific subject of the media currently being viewed by the customer and obtaining revenue from said advertisers. The advertising can be banners, ad placement, and embedding ads in the digital videos. Links can be placed in the presentation to allow viewers to purchase materials associated with the presentations.

Other techniques for presenting multimedia information can include storing on at least one computer server multimedia files that respectively correspond to articles, each multimedia file can include a video presentation of the subject matter of a respective article; and providing a user interface to enable an on-line user to search and view a list of articles for which multimedia files are available on the computer server and to select a multimedia file for viewing. In some implementations, these techniques can include making an on-line database of published articles available to on-line users via the user interface to allow a user to view information of an article stored in the on-line database; wherein a corresponding multimedia file for the article is stored on the computer server for retrieval.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of what is disclosed here, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

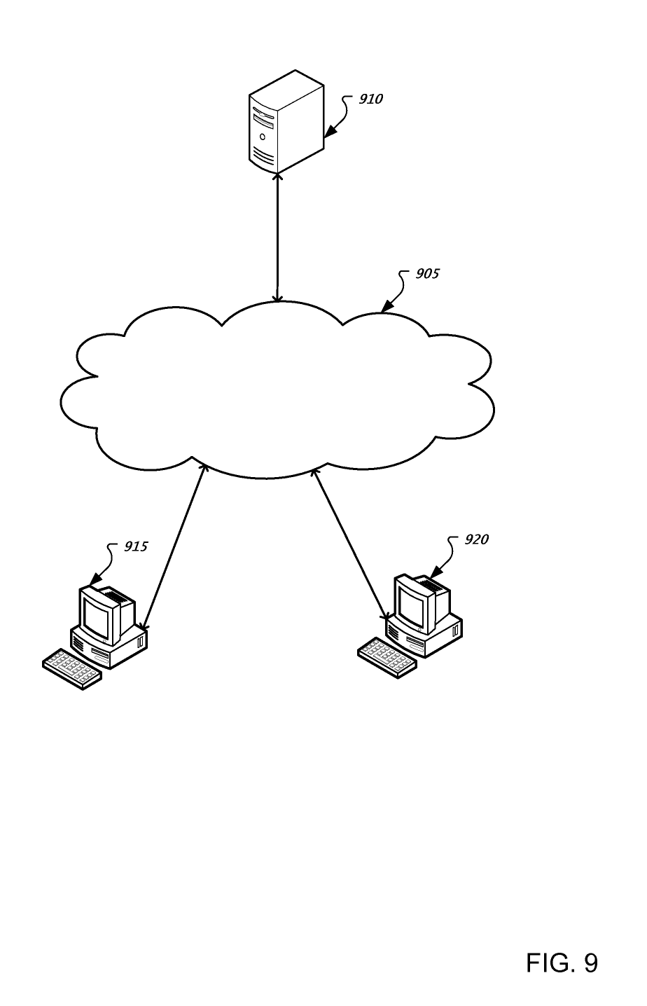

A computer system for implementing the disclosed embodiments can include client computers (clients) and server computers (servers). A client and a server are generally remote from each other and typically interact through a communication network. The relationship of client and server can arise by virtue of computer programs running on the respective computers and having a client-server relationship to each other. FIG. 9 shows an example of a communication network 905 such as the Internet connected with computing devices such as a server computer 910 and client computers 915, 920.

While this specification contains many specifics, these should not be construed as limitations on the scope of any invention or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims.

What is claimed is:

1. A method for generating a multimedia user interface for reviewing a scientific article by associating digital video content to the scientific article, comprising:
operating a network server to receive a scientific article;
operating a network server to receive a digital video whose contents describe at least a portion of the scientific article; and
generating a multimedia user interface responsive to the scientific article and the digital video.

2. The method of claim 1, wherein the generated multimedia user interface comprises a link to the digital video.

3. The method of claim 2, wherein generating the multimedia user interface comprises generating code to display at least a portion of the scientific article and the link.

4. The method of claim 1, further comprising:
generating mappings between the scientific article and the digital video, wherein each mapping identifies a section of the scientific article to a corresponding portion of the digital video;
generating links that correspond to the mappings; and
augmenting the multimedia user interface with at least a portion of the links.

5. The method of claim 4, wherein the links allow a user to view different portions of the digital video respective to ones link.

6. The method of claim 4, wherein the links allow a user to view different sections of the document respective to ones link.

7. The method of claim 1, wherein the generated multimedia user interface comprises a link to the scientific article.

8. The method of claim 7, wherein generating the multimedia user interface comprises generating code to view the digital video.

9. The method of claim 1, further comprising:
providing a user interface to rank the scientific article; and
receiving ranking information through the user interface.

10. The method of claim 1, further comprising:
augmenting the multimedia user interface with one or more advertisements.

11. A method for generating a multimedia user interface on a network server with synchronized digital video and document content, comprising:
receiving a document;
receiving a digital video that corresponds to the document;
generating a plurality of mappings, wherein each of the mappings maps a section of the document to a segment of the digital video; and
generating a multimedia user interface responsive to the document, the digital video, and the plurality of mappings.

12. The method of claim 11, wherein each mapping comprises a time offset relative to the digital video, a time range that begins at the time offset, and a section identifier that identifies a section of the document.

13. The method of claim 11, wherein generating the multimedia user interface comprises generating code for displaying the digital video, code for displaying at least a portion of the document, and code for synchronizing a display of at least a portion of the document with a display of the digital video by using the plurality of mappings.

14. The method of claim 11, wherein generating the multimedia user interface comprises creating links that correspond to one or more of the mappings.

15. The method of claim 11, wherein the document comprises text and one or more figures.

16. A method for displaying a multimedia user interface, comprising:
accessing a document, a digital video that corresponds to the document, and a plurality of mappings that are stored collectively between one or more storage mediums, wherein each of the mappings maps a section of the document to a segment of the digital video;
displaying a multimedia user interface responsive to the document, digital video, and the plurality of mappings;
playing the digital video;
identifying a corresponding section of the document that corresponds to a currently displayed portion of the digital video; and
displaying the corresponding section of the document in the multimedia user interface.

17. The method of claim 16, further comprising:
displaying the mappings as links in the multimedia user interface;
receiving a selection of a link via the multimedia user interface; and
starting the playing of the digital video with respect to a mapping identified by the received selection.

18. The method of claim 16, wherein the document comprises text and one or more figures.

19. The method of claim 16, further comprising:
displaying one or more advertisements in the multimedia user interface.

20. A system for generating a multimedia user interface for reviewing a scientific article by associating digital video content to the scientific article, comprising:
a communication network to provide connectivity to multiple computers; and
a first computer connected to the communication network, wherein the first computer performs operations comprising:
receiving a scientific article from the communication network;
receiving a digital video whose contents describe at least a portion of the scientific article from the communication network; and
generating a multimedia user interface responsive to the scientific article and the digital video.

21. The system of claim 20, wherein the generated multimedia user interface comprises a link to the digital video.

22. The system of claim 20, wherein generating the multimedia user interface comprises generating code to display at least a portion of the scientific article and the link.

23. The system of claim 20, the operations further comprising:
generating mappings between the scientific article and the digital video, wherein each mapping identifies a section of the scientific article to a corresponding portion of the digital video;
generating links that correspond to the mappings; and
augmenting the multimedia user interface with at least a portion of the links.

24. The system of claim 23, wherein the links allow a user to view different portions of the digital video respective to ones link.

25. The system of claim 23, wherein the links allow a user to view different sections of the document respective to ones link.

26. The system of claim 20, wherein the generated multimedia user interface comprises a link to the scientific article.

27. A system for generating a multimedia user interface with synchronized digital video and document content, comprising:
a communication network to provide connectivity to multiple computers; and
a first computer connected to the communication network, wherein the first computer performs operations comprising:
receiving a document from the communication network;
receiving a digital video that corresponds to the document from the communication network;
generating a plurality of mappings, wherein each of the mappings maps a section of the document to a segment of the digital video; and
generating a multimedia user interface responsive to the document, the digital video, and the plurality of mappings.

28. The system of claim 27, wherein each mapping comprises a time offset relative to the digital video, a time range that begins at the time offset, and a section identifier that identifies a section of the document.

29. The system of claim 27, wherein generating the multimedia user interface comprises generating code for displaying the digital video, code for displaying at least a portion of the document, and code for synchronizing a display of at least a portion of the document with a display of the digital video by using the plurality of mappings.

30. The system of claim 27, wherein generating the multimedia user interface comprises creating links that correspond to one or more of the mappings.

31. The system of claim 27, wherein the document comprises text and one or more figures.

32. A system for displaying a multimedia user interface, comprising:
a communication network to provide connectivity to multiple computers;
a first computer connect to the communication network; and
a second computer connected to the communication network, wherein the second computer performs operations comprising:
accessing a document, a digital video that corresponds to the document, and a plurality of mappings stored in the communication network, wherein each of the mappings maps a section of the document to a segment of the digital video;
displaying a multimedia user interface responsive to the document, digital video, and the plurality of mappings to the first computer;
playing the digital video to the first computer;
identifying a corresponding section of the document that corresponds to a currently displayed portion of the digital video; and
displaying the corresponding section of the document in the multimedia user interface to the first computer.

33. The system of claim 32, the operations further comprising:
displaying the mappings as links in the multimedia user interface to the first computer;
receiving a selection of a link via the multimedia user interface from the first computer; and
starting the playing of the digital video with respect to a mapping identified by the received selection.

34. The system of claim 32, wherein the document comprises text and one or more figures.

35. The system of claim 32, further comprising:
displaying one or more advertisements in the multimedia user interface.
